(19) United States
(12) Patent Application Publication
(10) Pub. No.: US 2005/0262290 A1
(43) Pub. Date: Nov. 24, 2005

(54) System for displaying the volume label text of a storage apparatus and a method thereof

(76) Inventors: Hsiang-An Hsieh, Hsintien City (TW); Chia-Li Chen, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/040,025

(22) Filed: Jan. 24, 2005

(30) Foreign Application Priority Data
May 18, 2004 (TW) 93113997

(51) Int. Cl. G06F 12/00

(52) U.S. Cl. 711/100; 711/4

(57) ABSTRACT

A system for displaying the volume label text of a storage apparatus and a method thereof is provided. The present system connects electrically the system interface to the storage apparatus and executes the transform program. The present method comprises starting up a storage apparatus, detecting whether a graph volume label information is loaded or not, checking the sort of the graph volume label information, checking whether the display text is based on a volume label format or not, checking whether the text code of the volume label matches or not, and displaying the graph information of the volume label. The present invention can utilize the fonts and the code of the fonts that are included in the application system, transforming them to the format that is compatible with the display unit of the storage apparatus, and saving it to a specified location in the storage apparatus.

### BACKGROUND OF THE INVENTION

1. Field of the Invention

The present invention relates to a system for displaying the volume label text of a storage apparatus and a method thereof. In particular, this invention provides a system and method for displaying the volume label and a multi-language text on a storage apparatus.

2. Description of the Related Art

Portable storage apparatuses are becoming more and more popular. In the market, most of the storage apparatuses can display the total volume of the device, for example, a USB flash disk. Although this display information is useful for the user, it still has some shortcomings. Firstly, the storage apparatus doesn't have a display unit, so the user doesn't know how much storage volume is left when the user accesses the files from the storage apparatus. Secondly, the user may have a variety of storage apparatuses, so the user needs to know which storage apparatus they are using. This is inconvenient for the user.

### SUMMARY OF THE INVENTION

The main purpose of the present invention is to provide a system for displaying the volume label text of a storage apparatus and a method thereof. This invention provides a system and method for displaying the volume label and a multi-language text on a storage apparatus to improve the shortcomings described above.

In order to achieve the above goal, the present invention provides a system for displaying the volume label text of a storage apparatus and a method thereof. The present system electrically connects the system interface to the storage apparatus and executes the transform program. The present method comprises: starting up a storage apparatus, detecting whether a graph volume label information is loaded or not, checking the sort of graph volume label information, checking whether the display text is based on a volume label format or not, checking whether the text code of the volume label is matched or not, and displaying the graph information of the volume label. The present invention can utilize the fonts and the code of the fonts that are included in the application system, transform them to the format that is compatible with the display unit of the storage apparatus, and save them to a specified location in the storage apparatus. The present system achieves the goal of displaying a multi-language text and reduces manufacturing costs.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the first embodiment of the present storage apparatus and the application system;

FIG. 2 is a block diagram of the second embodiment of the present storage apparatus and the application system;

FIG. 3 is a block diagram of the third embodiment of the present storage apparatus and the application system;

FIG. 4 is a flow chart of the present method of displaying the volume label text of a storage apparatus;

FIG. 5 is a flow chart of the present displaying method of the user utilizing the transform program to input the specified character/graph into the storage apparatus;

FIG. 6 is a flow chart of displaying built-in text information of the present method; and

FIG. 7 is a panel with matrix pixels of the present invention.

### DETAILED DESCRIPTION OF THE PREFERRED EMBODIMENTS

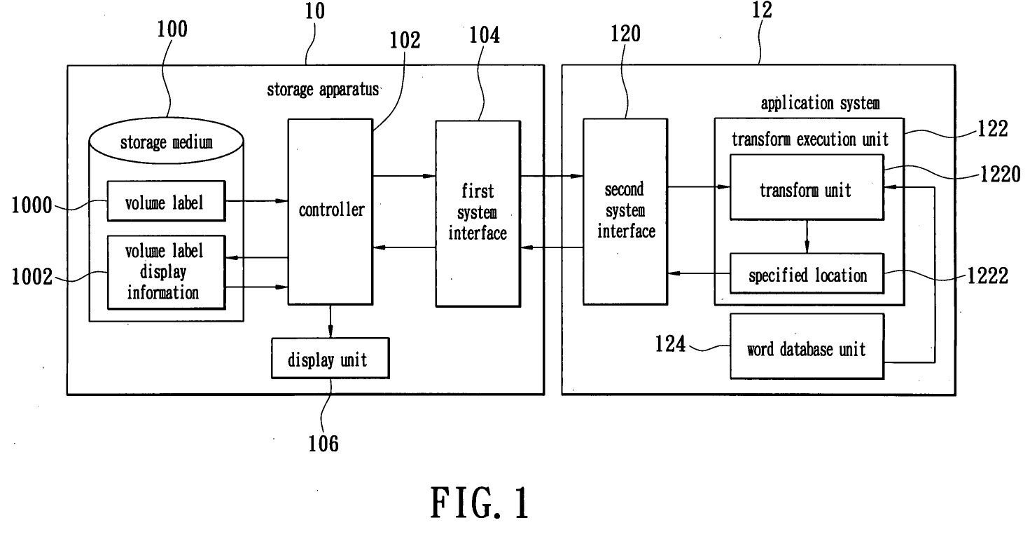

Please refer to FIG. 1, which shows a block diagram of the first embodiment of the present storage apparatus and application system. The present invention comprises a storage apparatus 10 and an application system 12. The application system 12 is a personal computer, a notebook or a personal digital assistant. The application system 12 also can be any kind of system. The storage apparatus 10 communicates the information with the application system 12 through a first system interface 104 and a second system interface 120. The storage apparatus 10 further comprises a storage medium 100, a controller 102, and a display unit 106. The storage medium 100 comprises a volume label 1000 and a volume label display information 1002. The present system displays the storage volume of the storage apparatus by electrically connecting the controller 102 with the storage medium 100, the display unit 106 and the first system interface 104.

The application system 12 includes a transform execution unit 122; the transform execution unit 122 connects a word database unit 124 and a second system interface 120. The information stored in the word database unit 124 includes the character codes and the corresponding fonts. A transform unit 1220 that is included in the transform execution unit 122 transforms the character codes/fonts into a graph volume label text and assigns a specified location 1222. After that, the graph volume label text is transmitted to the storage apparatus 10 through the second system interface 120 and is displayed on the display unit 106.

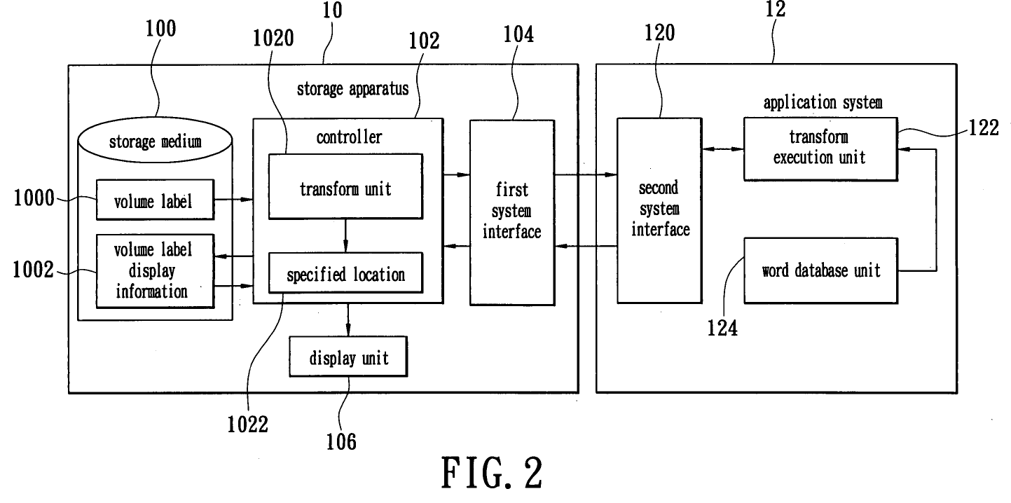

Please refer to FIG. 2, which shows a block diagram of the second embodiment of the present storage apparatus and application system. The present invention comprises a storage apparatus 10 and an application system 12. The application system 12 is a personal computer, a notebook or a personal digital assistant. The application system 12 also can be any kind of system. The storage apparatus 10 communicates the information with the application system 12 through a first system interface 104 and a second system interface 120. The storage apparatus 10 further comprises a storage medium 100, a controller 102, and a display unit 106. The storage medium 100 comprises a volume label 1000 and a volume label display information 1002. The present system displays the storage volume of the storage apparatus by connecting electrically the controller 102 with the storage medium 100, the display unit 106 and the first system interface 104. The controller 102 includes a transform unit 1020 and a specified location 1022.

The application system 12 includes a transform execution unit 122; the transform execution unit 122 connects a word database unit 124 and a second system interface 120. The information stored in the word database unit 124 includes the character codes and the corresponding fonts. The character codes/fonts included in the word database unit 124 are transmitted to a transform unit 1020 in the controller 102 through the transform execution unit 122 and the second system interface 120. After this, the character codes/fonts are transformed to a graph volume label text and saved in a specified location 1222. The display unit 106 of the storage apparatus 10 displays the graph volume label text fitting with the volume label display information 1002.

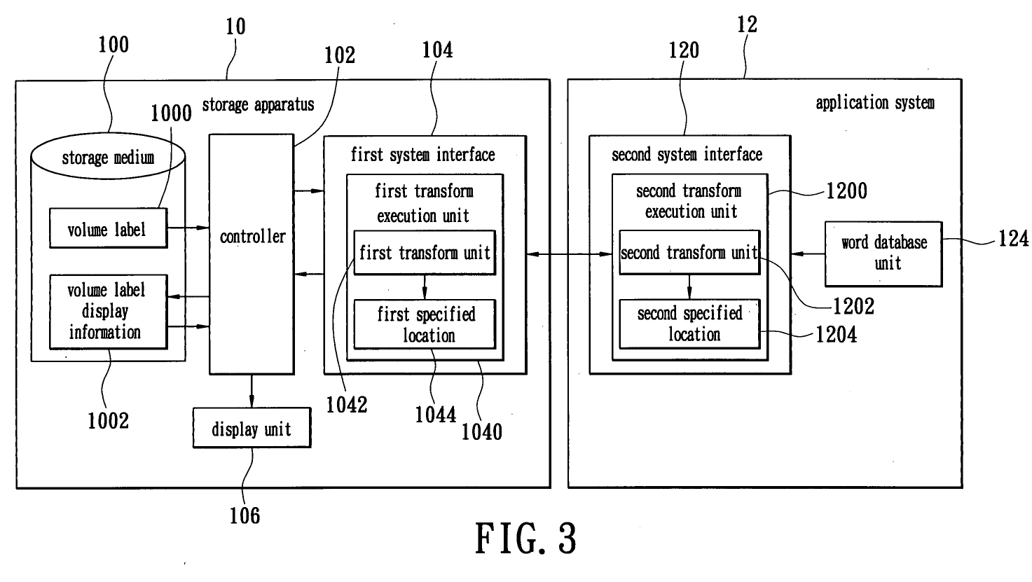

Please refer to FIG. 3, which shows a block diagram of the third embodiment of the present storage apparatus and application system. The present invention comprises a storage apparatus 10 and an application system 12. The application system 12 is a personal computer, a notebook or a personal digital assistant. The application system 12 also can be any kind of system. The storage apparatus 10 communicates the information with the application system 12 through a first system interface 104 and a second system interface 120. The storage apparatus 10 further comprises a storage medium 100, a controller 102, and a display unit 106. The storage medium 100 comprises a volume label 1000 and a volume label display information 1002. The present system displays the storage volume of the storage apparatus by connecting electrically the controller 102 with the storage medium 100, the display unit 106 and the first system interface 104. The first system interface 104 includes a first transform execution 1040, and the first transform execution 1040 further comprises a first transform unit 1042 and a first specified location 1044.

The application system 12 includes a second system interface 120 and a word database unit 124. The second system interface 120 includes a second transform execution unit 1200, and the second transform execution 1200 further comprises a second transform unit 1202 and a second specified location 1204. The information stored in the word database unit 124 includes the character codes and the corresponding fonts. A first transform unit 1042 that is included in the first transform execution unit 1040 in the first system interface 104 transforms the character codes/fonts into a graph volume label text and assigns them to a first specified location 1044. After that, the display unit 106 connected to the controller 102 displays the graph volume label text fitting with the volume label display information 1002 of the storage apparatus 10.

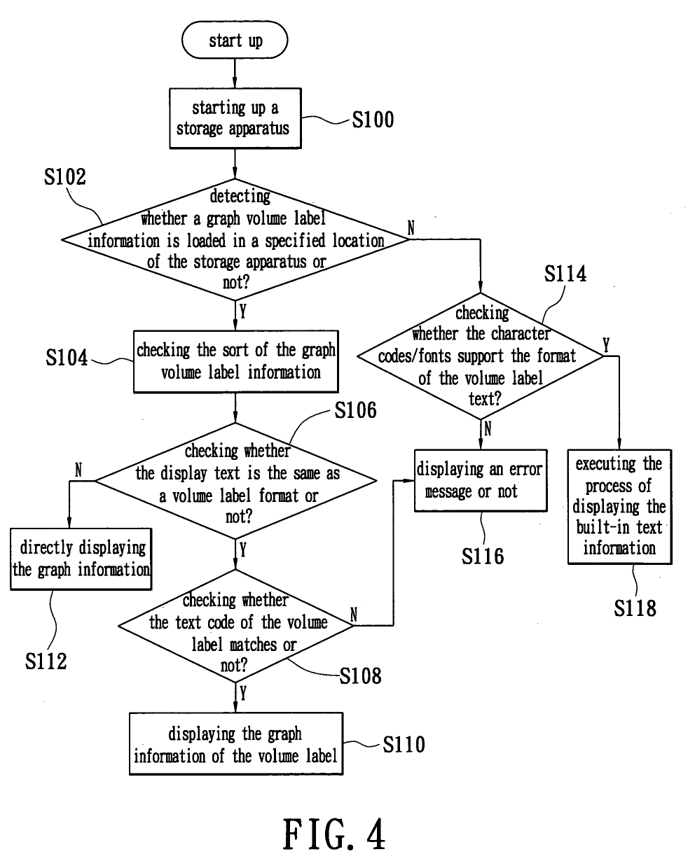

Please refer to FIG. 4, which shows a flow chart of the present method of displaying the volume label text of a storage apparatus. The application system is electrically connected to the storage apparatus through the system interface and executes a transform program. The present method comprises starting up a storage apparatus (S100); detecting whether a graph volume label information is loaded in a specified location of the storage apparatus or not (S102); if yes, checking the sort of the graph volume label information (S104), including the sort of text and graph, for example the display format; checking whether the display text is the same as a volume label format or not (S106); after that, checking whether the text code of the volume label is matched or not (S108), that means the text code of the display information is matched with the text code included in the word database unit; if yes, displaying the graph information of the volume label (S110); if not, to display an error message or not.

The transform program mentioned above is an application program, a driving program or a function program composed of a plurality of subprograms with the function of transforming text data into graph data. The transform program transforms character codes/fonts and saves them in a specified location. The transform program can be executed by the application system, the controller of the storage apparatus or the commutation protocol supported by the system interface.

Moreover, during the step of detecting whether a graph volume label information is loaded in a specified location of the storage apparatus or not (S102), if the result is no, the storage apparatus checks whether the character codes/fonts support the format of the volume label text (S114). If the character codes/fonts match the format of the volume label text, the storage apparatus executes the process of displaying the built-in text information (S118), if not, the storage apparatus displays the error message or not the graph information of the volume label (S116). In the step of checking whether the display text is the same as a volume label format or not (S106), if the result is no, it means the input from the user is not text and is a specified graph, at this time, the storage apparatus directly displays the graph information (S112).

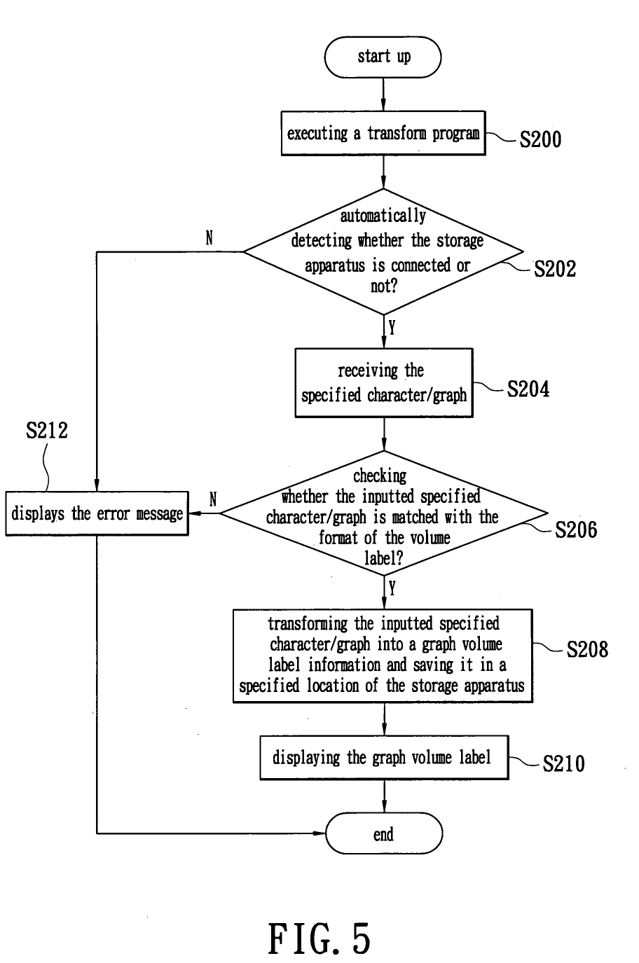

Please refer to FIG. 5, which shows a flow chart of the present displaying method of the user utilizing the transform program to input the specified character/graph into the storage apparatus. The present method comprises executing a transform program (S200). The transform program is an application program or a driving program or a function program composed of a plurality of subprograms that transforms the text data into graph data. The transform program transforms character codes/fonts and saves them in a specified location. The transform program can be executed by the application system, the controller of the storage apparatus or the commutation protocol supported by the system interface.

Next the transform program automatically detects whether the storage apparatus is connected or not (S202). If yes, the transform program receives the specified character/graph (S204). The transform program then checks whether the inputted specified character/graph matches the format of the volume label (S206); if yes, the transform program transforms the inputted specified character/graph into a graph volume label information and saves it in a specified location of the storage apparatus (S208). Finally, the transform program displays the graph volume label information on the display unit of the storage apparatus (S210) and unloads the transform program.

Additionally, in the step of detecting whether the storage apparatus is connected or not (S202), if the storage apparatus is not connected, the transform program displays the error message on the display unit of the storage apparatus (S212) and stops the execution of the transform program. In the step of checking whether the inputted specified character/graph is matched with the format of volume label (S206), if the inputted specified character/graph is not matched with the format of volume label, the transform program displays the error message on the display unit of the storage apparatus (S212).

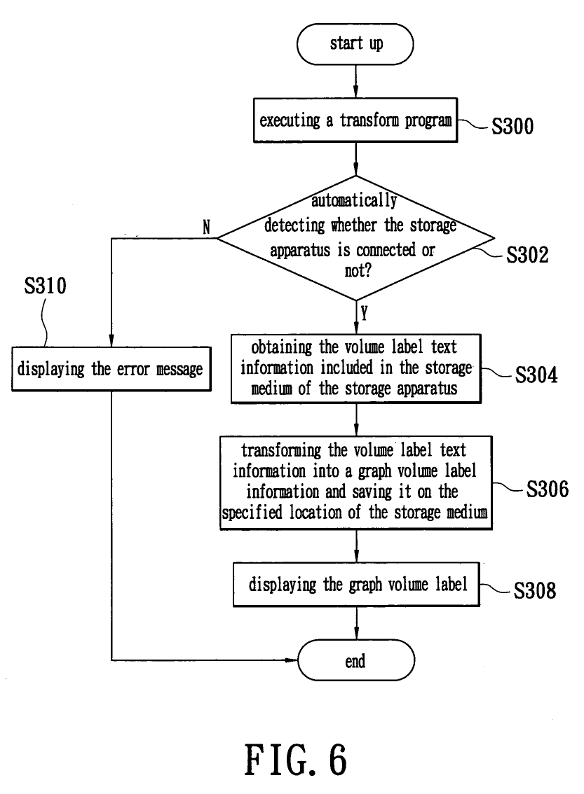

Please refer to FIG. 6, which shows a flow chart of displaying a built-in text information of the present method. The present method comprises executing a transform program (S300). The transform program can be executed by the application system, the controller of the storage apparatus or the commutation protocol supported by the system interface.

Next, the transform program automatically detects whether the storage apparatus is connected or not (S302). If not, the transform program displays the error message on the display unit of the storage apparatus (S310). If the storage apparatus has already connected with the application system, the transform program gets the volume label text information included in the storage medium of the storage apparatus (S304). The volume label text information is inputted by the user. Then the storage apparatus does a mapping operation with the volume label text information and the built-in character codes/fonts. Then, the transform program transforms the volume label text information into graph volume label information and saves it on the specified location of the storage medium (S306). Finally, the transform program displays the graph volume label information on the display unit of the storage apparatus (S308) and unloads the transform program.

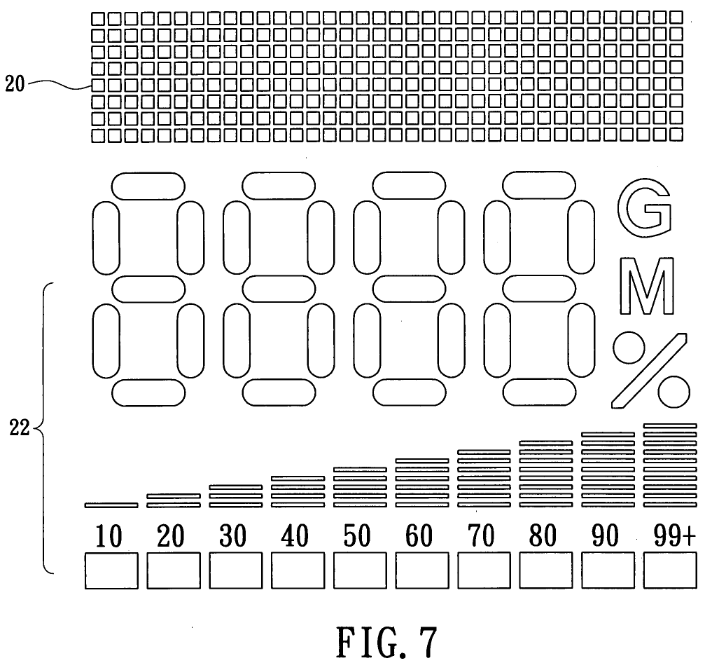

The main objective of the present invention is to display the volume label and the volume label display information on the display unit of the storage apparatus. The volume label display information includes the display test and the display graph. For solving the problem of displaying text, the display unit is a pixel matrix panel. The display unit comprises a pixel matrix panel 20 that can show the text and graph and a pixel matrix panel 22 that can show the residual volume. Please refer to FIG. 7. The type of unit used to display the residual volume of the storage medium can be a seven-segment display unit and/or a volume unit, this displays the percentages of total volumes, or other types of information that show the level of used volume.

The present invention develops a transform program in the application system. This transform program transforms the character codes/fonts of a volume label set by the user into a graph code. The transform program then saves the graph code in the specified location of the storage medium. The specified location is preset on the application system or the storage apparatus. The first method saves the graph code in a hidden file located in the root direction. In order to prevent the hidden file from being deleted, another method is provided. The space located on the rear location of the storage medium is separated and used for saving the graph code. The space is only accessed by a specified command. The application program records the graph information on the space through a specified command.

When the graph code is saved in the storage apparatus, the present invention just needs to get the graph code and display it on the display unit; the content of the volume label is irrelevant. The storage apparatus of the present invention doesn't need to embed any character codes/fonts. Of course, some checking code can be added. For example, adding a volume label code after the graph code makes the controller check whether the volume label code matches with the volume label saved in the storage apparatus, before the graph code is displayed.

When the volume label code is mismatched with the volume label saved in the storage apparatus, the transform program needs to be re-executed to get the volume label, transform the volume label, and renew the display graph information. An exception is displaying the volume label text, in which case the user also can display a specified graph through the present invention. The transform program of this invention provides a specified mode that allows the user to directly edit or transform a specified graph located in the application system. It means a graph code can be directly inputted into the storage apparatus and displayed. Under this condition, the storage apparatus doesn't need to check whether the graph information matches the volume label. The user gives a command to the storage apparatus for displaying the graph through the transform program, and the storage apparatus directly displays the graph. The user can display a personalized graph by utilizing this pixel matrix display panel.

The transform program does not display the graph directly. It displays the graph through the controller. The transform program records the graph information in a specified location of the storage medium and uses a specified format. The storage apparatus displays the storage information. The graph information has two sources. One comes from the volume label. The storage apparatus recognizes graph information as belonging to a particular font through the font code and transforms the font into a display format that matches the display penal. Another one comes from the personalized graph that is set by the user. If the user does not want to show the text, say because the user thinks the text is boring, the user can display the specified graph through a specified mode provided by the transform program. In this mode, the transform program does not need to check the text or font of the volume label and allows the user to input the graph and display the graph directly.

In order to display the fonts or graphs that are not embedded in the controller of the storage apparatus, the controller needs to find a specified graph information file in a specified location according to a preset spec. The content of the file is the graph information that will be displayed on the storage apparatus, according to the mode set by the user. The graph information includes a word code that is matched with the volume label. The controller of the storage apparatus uses the word code to perform a check. When the word code does not match, an error message will be displayed telling the user to re-execute the application program to renew the graph information. When the user directly sets a specified graph, not displaying the volume label information, it matches the mode set by the user. The application program sets a code according to the graph information and informs the storage apparatus to directly display the specified graph.

The description above only illustrates specific embodiments and examples of the invention. The invention should therefore cover various modifications and variations made to the herein-described structure and operations of the invention, provided they fall within the scope of the invention as defined in the following appended claims.

1. a method for displaying the volume label text of a storage apparatus, a application system connects electrically to the storage apparatus through a system interface and executes a transform program, the transform program comprising:
starting up a storage apparatus;
detecting whether a graph volume label information is loaded or not;
checking the sort of the graph volume label information;
checking whether the display text is based on a volume label format or not;
checking whether the text code of the volume label matches or not; and
displaying the graph information of the volume label.

2. The method for displaying the volume label text of a storage apparatus of claim 1, wherein the step of detecting whether a graph volume label information is loaded or not, if the result is no, checking whether the character codes/fonts supports the format of the volume label text or not. If the character codes/fonts match with the format of the volume label text, executing the process of displaying the built-in text information, if not, displaying the error message or not.

3. The method for displaying the volume label text of a storage apparatus of claim 1, wherein the step of checking the sort of the graph volume label information, the graph volume label information is text or a graph.

4. The method for displaying the volume label text of a storage apparatus of claim 1, wherein the step of checking whether the display text is based on a volume label format or not, if not, directly displaying the graph information.

5. The method for displaying the volume label text of a storage apparatus of claim 1, wherein the step of checking whether the text code of the volume label is matched or not, it the result is not, displaying the error message or not.

6. a method for displaying a specified character/graph of a storage apparatus, comprising:
executing a transform program;
automatically detecting whether the storage apparatus is connected or not;
receiving the specified character/graph;
checking whether the specified character/graph matches the format of the volume label;
transforming the specified character/graph into a graph volume label information and saving the graph volume label information in the storage medium; and
displaying the graph volume label.

7. The method for displaying a specified character/graph of a storage apparatus of claim 6, wherein the step of transforming the specified character/graph into a graph volume label information and saving the graph volume label information in the storage medium, means transforming the specified character/graph into a graph volume label information and saving the graph volume label information in a specified location of the storage medium.

8. The method for displaying a specified character/graph of a storage apparatus of claim 6, wherein the step of transforming the specified character/graph into a graph volume label information and saving the graph volume label information in the storage medium, is performed in a transform execution unit of the application system, or in the controller of the storage apparatus or in the commutation protocol supported by the system interface.

9. The method for displaying a specified character/graph of a storage apparatus of claim 6, wherein the step of automatically detecting whether the storage apparatus is connected or not, if the storage apparatus is not connected, displaying the error message on the display unit of the storage apparatus.

10. The method for displaying a specified character/graph of a storage apparatus of claim 6, wherein the step of checking whether the specified character/graph is matched with the format of volume label, if the result is not, displaying the error message.

11. The method for displaying a built-in text information, the method comprising:
executing a transform program;
automatically detecting whether the storage apparatus is connected or not;
obtaining the volume label text information included in the storage medium of the storage apparatus;
transforming the volume label text information into a graph volume label information and saving it on the storage medium; and
displaying the graph volume label.

12. The method for displaying the built-in text information of claim 11, wherein the step of transforming the specified character/graph into a graph volume label information and saving the graph volume label information in the storage medium, means transforming the specified character/graph into a graph volume label information and saving the graph volume label information in a specified location of the storage medium; wherein the step of transforming the specified character/graph into a graph volume label information and saving the graph volume label information in the storage medium, is performed in a transform execution unit of the application system, or in the controller of the storage apparatus or in the commutation protocol supported by the system interface.

13. The method for displaying a built-in text information of claim 1, wherein the step of automatically detecting whether the storage apparatus is connected or not, if the storage apparatus is not connected, displaying the error message on the display unit of the storage apparatus.

14. The method for displaying a built-in text information of claim 111, wherein the step of transforming the specified character/graph into a graph volume label information and saving it on the storage medium, doing mapping the volume label text information and the built-in character codes/fonts and then transforming the volume label text information into a graph volume label information and saving it on the specified location of the storage medium.

15. A system for displaying the volume label text of a storage apparatus, comprising:
a storage apparatus, connecting with a storage medium, a display unit and a first system interfacing through a controller, the storage medium includes a volume label and a volume label display information; and
an application system, connecting with a word database unit and a second system interfacing through a transform execution unit;
wherein, the storage apparatus connects electrically with the application system through the first system interface and the second system interface.

16. The system for displaying the volume label text of a storage apparatus of claim 15, wherein the display unit is an additional display apparatus.

17. The system for displaying the volume label text of a storage apparatus of claim 15, wherein the word database unit saves a character code/font data for the system, and receives and saves a character code/font data that comes from the user.

18. The system for displaying the volume label text of a storage apparatus of claim 15, wherein the transform execution unit has a transform unit and a specified location, the transform unit receives and transforms the character code/font data, and saves the result in the specified location.

19. The system for displaying the volume label text of a storage apparatus of claim 15, wherein the controller of the storage apparatus has a transform unit and a specified location, the transform unit receives and transforms the character code/font data, and saves the result in the specified location.

20. The system for displaying the volume label text of a storage apparatus of claim 15, wherein the first system interface has a first transform execution unit, and the first transform execution unit has a first transform unit and a first specified location, the first transform unit receives and transforms the character code/font data, and saves the result in the first specified location, the second system interface has a second transform execution unit, and the second transform execution unit has a second transform unit and a second specified location, the second transform unit receives and transforms the character code/font data, and saves the result in the second specified location.
